(19) United States
(12) Patent Application Publication
(10) Pub. No.: US 2012/0095750 A1
(43) Pub. Date: Apr. 19, 2012

(54) PARSING OBSERVABLE COLLECTIONS

(75) Inventors: Henricus Johannes Maria Meijer, Mercer Island, WA (US); John Wesley Dyer, Monroe, WA (US); Daniel Johannes Pieter Leijen, Bellevue, WA (US)

(73) Assignee: MICROSOFT CORPORATION, Redmond, WA (US)

(21) Appl. No.: 12/904,831

(22) Filed: Oct. 14, 2010

(51) Int. Cl. G06F 17/27; G06F 17/30

(52) U.S. Cl. 704/9; 707/758; 707/E17.039

(57) ABSTRACT

Parsing technology is applied to observable collections. More specifically, a parser, such as combinator parser, can be employed to perform syntactic analysis over one or more observable collections. Further, multiple observable collections can be combined into a single collection and time can be captured by annotating collection items or generating time items.

### BACKGROUND

Parsers enable programs to recognize patterns matching formal grammars. More specifically, parsers can perform syntactic analysis of an input sequence in multiple steps. First, a sequence of characters can be lexically analyzed to recognize tokens such as keywords, operators, and identifiers, among others. In other words, an input sequence is preprocessed. For example, consider the following input sequence including whitespaces: “{, v, a, r, , x, , =, , x, , +, , 1, ;,}.” Lexical analysis can produce the following sequence of tokens “{,” “var,” “x,” “=,” “x,” “+,” “1,” “;” “}.” Next, these tokens can be employed to produce a parse tree or more compact abstract syntax tree (AST) as a function of a programming language grammar, which can be employed for subsequent analysis, optimization, and code generation. Further to the above example, “{var x=x+1;}” can be represented in a hierarchical format

Parsing is conventionally a pull-based computation. For example, the parser can request the next token. In response, a lexer, performing lexical analysis, pulls on an input sequence to read the next one or more characters that form a token that is provided back to the parser. Subsequently, the parser asks for the next token and the process continues. The input sequence typically exists in a string or file, for example, and the process of discovering a pattern or structure in the input is pull-based. Whenever a consuming process needs to know more, it asks for the next value. For example, the parser asks for the next token, and the lexer asks for the next character.

Many parsers are written by hand while others are generated automatically. For example, a grammar can be provided from which a parser is generated. In particular, regular expressions can be utilized to facilitate automatic generation of a parser based on the grammar, wherein regular expressions provide a concise means for finding or matching a sequence of characters in an existing string or file, for example. Regardless, parsers as well as regular expressions are pull-based such that a consumer of input is in control of data acquisition.

Furthermore, both parsers and regular expression engines can employ arbitrary look ahead and/or backtracking (negative look ahead) to facilitate recognition of a pattern of input. For instance, with respect to parsing, a look ahead specifies a maximum number of tokens that can be utilized before deciding what grammar rule to utilize. Backtracking refers to utilization of one or more previously acquired tokens to identify an appropriate grammar rule. In the case of look ahead and backtracking, such functionality can be implemented by simply moving a pointer in an input sequence forward or backward and subsequently pulling input from the sequence at the position identified by the pointer.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure generally pertains to parsing observable collections. More particularly, parsing technology is utilized to facilitate recognition of patterns with respect to observable collections. In accordance with one embodiment, a combinator parser can be generated and employed to recognize patterns in one or more observable collections. Furthermore, items from two or more observable collections can be added to a single observable collection to facilitate processing, and time can be captured by annotating observable collection items with time or generating time items.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a data processing system.

FIG. 2 is a block diagram of a representative collection-processor component.

FIG. 3A depicts a first representation of item time.

FIG. 3B illustrates a second representation of item time.

FIG. 4 is a block diagram of a representative recognizer component.

FIG. 5 depicts a sample left factoring of events with failure.

FIG. 6 is a block diagram of a system of data processing.

FIG. 7 is a flow chart diagram of a method of processing data.

FIG. 8 is a flow chart diagram of a method of collection combination.

FIG. 9 is a flow chart diagram of a method of capturing item time.

FIG. 10 is a flow chart diagram of a method of capturing item time.

FIG. 11 is a flow chart diagram of a method of data processing.

FIG. 12 is a schematic block diagram illustrating a suitable operating environment for aspects of the subject disclosure.

### DETAILED DESCRIPTION

Details below are generally directed toward parsing observable collections. Conventionally, parsers are employed to operate over strings, files, or other pull-based or enumerable collections. However, parsers can also be utilized to identify patterns over push-based data, or in other words, observable collections such as event streams. In one embodiment, a combinator parser can be employed, which is a parser that is constructed piecewise from primitive or less complex parsers. In other words, parser combinators can be employed that utilize basic parsers to build more complex parsers and complex parsers to build parsers that are even more complex. Further yet, multiple observable collections can be combined into a single observable collection, and observable collection items can be annotated with time or separate time items can be generated to facilitate parsing.

Conventional parser technology can be adapted to facilitate employment over push-based or observable collections. Backtracking and look ahead are commonly utilized by conventional parsing systems over pull-based or enumerable collections. However, the asynchronous nature of observable or push-based data makes backtracking or buffering of input difficult or impossible. Furthermore, a parser is not able to look ahead with respect to push-based data that has not yet been provided. Nevertheless and as described further herein, limited backtracking and look ahead functionality can be provided, if needed, to parse observable collections.

Various aspects of the subject disclosure are now described in more detail with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

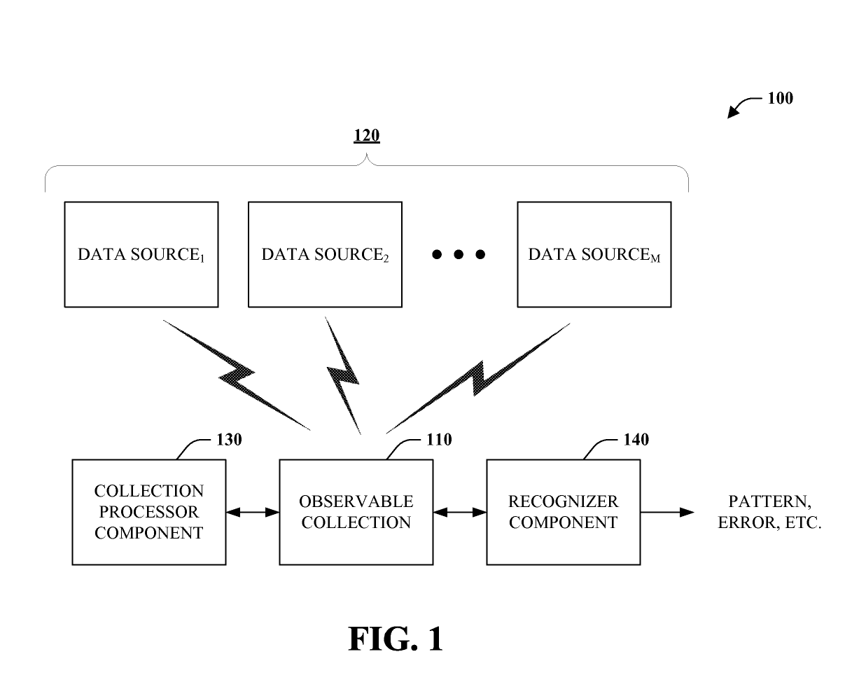

Referring initially to FIG. 1, a data processing system 100 is illustrated. The data processing system 100 includes an observable collection 110 that represents a dynamic collection of data, wherein the data corresponds to items that are pushed thereto at arbitrary times, among other things. As shown, one or more data sources 120 (DATA SOURCE₁-DATA SOURCE_{M}, where M is an integer greater than or equal to one) can provide items to the observable collection 110. Stated differently, the data sources 120 operate with respect to a push-based computation model, wherein the data sources 120 push data to a consumer asynchronously, rather than having data pulled from the data sources 120 by the consumer.

The observable collection 110 can be thought of, or represented as, a stream of data because of the collection's dynamic nature. Accordingly, events or, in other words, event streams can be one type of observable collection 110. For example, the observable collection 110 can be a stream of stock prices or weather data provided at arbitrary times. Of course, the observable collection 110 is not limited to events. Other push-based collections that are not conventionally viewed as events can be a type of observable collection 110 such as but not limited to results of asynchronous computations.

Furthermore, in one particular embodiment, the observable collection 110 can refer a collection of data with respect to an “IObservable” interface or the like of programming languages such as but not limited to C#®, which provides a generalized mechanism for push-based notification, also known as the observer design pattern. More specifically, an “IObservable” interface can expose an “IObserver” interface, wherein “IObservable<T>” represents a class that sends notifications (provider) and “IObserver<T>” represents a class that receives the notifications (observer). Here, “T” represents the class or type of notification.

The data processing system 100 also includes a collection-processor component 130 communicatively coupled with the observable collection 110 and configured to perform some action on the observable collection 110. For example, the collection-processor component 130 can perform some pre-processing on the observable collection 110 to facilitate further processing by a recognizer component 140.

The recognizer component 140 is communicatively coupled with the observable collection 110 and configured to analyze the observable collection and output a recognized pattern, an error, or other message. As will be described further hereinafter, the recognizer component 140 can utilize parser technology heretofore reserved for the processing of strings, files or other pull-based or enumerable data collections.

Among other things, the function functionality provided by the recognizer component 140 can allow patterns amongst push-based data at a lower abstraction level to be discovered and utilized to create patterns at a higher abstraction level, among other things. For example, suppose in an event stream of mouse events it is desirable to detect that a mouse has moved over some control by looking for the pattern “mouseover, . . . , mousemove, mouseout.” This pattern can now be replaced with a higher level of abstraction, such as “mouse over control events.”

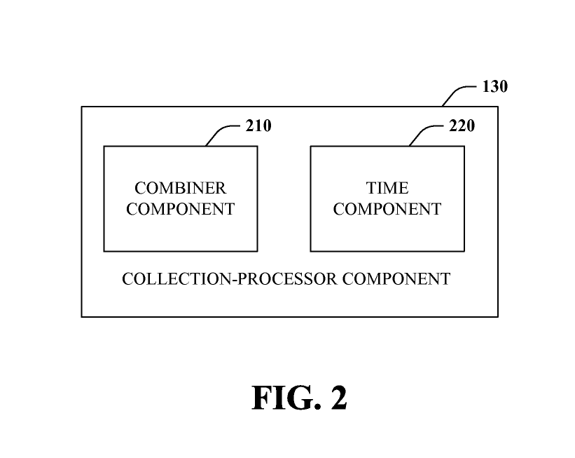

Turning to FIG. 2 a representative collection-processor component 130 is illustrated in detail. As shown, the collection-processor component 130 includes a combiner component 210 and a time component 220. The combiner component 210 generates a single observable collection from two or more observable collections without losing information. In particular, the combiner component 210 can generate a new item for a particular observable collection, wherein the new item is annotated with a class or type of an item and includes associated data provided by the item. This new item can then be added to a single observable collection including items and associated data from multiple different observable collections.

By way of example and not limitation, an event stream can provide stock price events and the combiner component 210 can generate new events from the stock price events to be added to a stream that notes the fact that the event is a stock price and includes data such as the actual stock and price. In this manner, this event can be distinguished in a single stream from other events provided from other streams such as a stream that provides weather related events, for example. More abstractly, three event streams “A,” “B,” and “C” with respective events “A1,” “B1,” and “C1” can be combined into a single stream “D” that includes events “A1, B1, and C1.”

Time component 220 captures item times. Data items by pushed to an observable collection at arbitrary times, and the significance of data provided by items can be time dependent (e.g., time item was provided, duration of time between items . . . ). The time component 220 can capture times associated with provisioning of items in various ways.

In one instance, upon receipt of an item from a source, the time the event was received can be noted and added to the event in some manner. For example, an item can be annotated with a time stamp. As a result, capturing duration between items of data becomes irrelevant since the time between items can be easily computed.

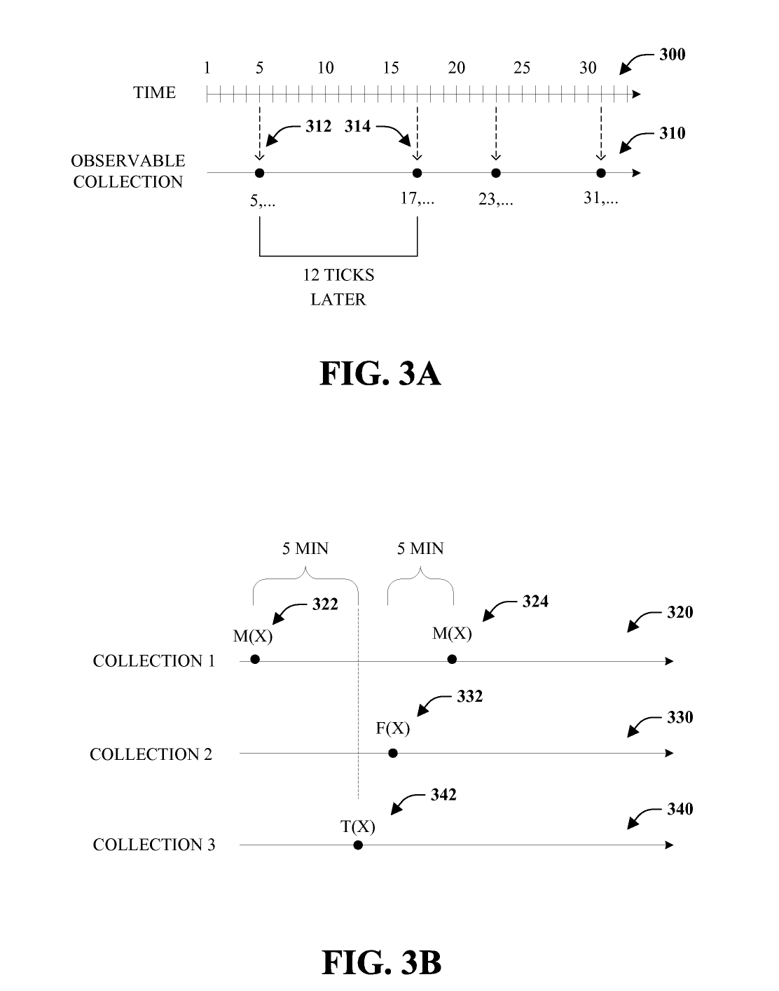

Turning attention briefly to FIG. 3A time is represented in increments of one by vertical lines or ticks on a time line 300 and items are shown as part of an observable collection 310. Times determined from the time line 300 can be mapped to respective items in the observable collection 310. In particular, the first item 312 can be annotated with time “5” and the second item 314 can be annotated with time “17” wherein the duration of time between the occurrence of the first item 312 and the second item 314 can be computed as the difference between the two times, namely “12” ticks or other units of time.

In another embodiment, the time component 220 can inject time items into a new or existing observable collection (e.g., time stream). For instance, the time item can represent some significant time relevant to other items. By way of example, a pattern can specify that two items were acquired within a particular timeframe. More particularly, a pattern can specify a match if an item “M” occurs within five minutes of event ‘B.”

FIG. 3B provides a graphical representation of such a time representation scenario. As depicted, there are three observable collections “COLLECTION 1” 320, “COLLECTION 2” 330, and “COLLECTION 3” 340. “COLLECTION 1” 320 includes “M” items and includes a first “M” item 322 and a second “M” item 324. “COLLECTION 2” 330 includes one “F” item 332, and “COLLECTION 3” 340 includes a single time item 342. Here, a time item is created every five minutes. Given a pattern that specifies the occurrence of an “M” item within five minutes of an “F” item, if a time item “T” occurs between an “M” item and an “F” item, there is no match, while if no time item “T” occurs between “M” item and an “F” item, then there is a match. In FIG. 3B, there is no match between a first “M” item 322 and a first “F” item 322 since time item “T” 342 occurred. However, there is a match between the second “M” item 324 and the first “F” item 332 because there was no time item “T” between these two items.

Notice that the time component 220 of FIG. 2 can return the same result regardless of implementation. In the first instance, the difference between time stamps can be utilized to determine a match. By contrast, occurrence of a generated time item between two items can be utilized.

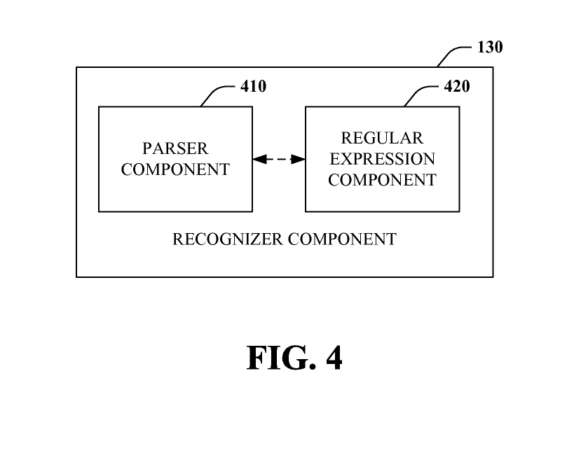

Referring to FIG. 4 a representative recognizer component 140 is illustrated. As previously mentioned, the recognizer component 140 can be employed to recognize or otherwise identify specified patterns amongst observable collections. In accordance with one embodiment, the recognizer component 140 can be implemented with a parser component 410 that syntactically analyzes item occurrences in an attempt to locate a particular pattern. Alternatively, regular expression component 420 can utilize regular expressions to identify a specified pattern. Still further yet, both the parser component 410 and the regular expression component 420 can be employed wherein the regular expression component 420 performs a lexing function to generate and subsequently provide tokens to the parser component 410 for use thereby. Accordingly, it is to be appreciated that the parser component 410 is capable of detecting more complex patterns than the regular expression component 420.

Furthermore, the parser component 410 and the regular expression component 420 can be combinatory and compositional in nature. In particular, the parser component 410 can be embodied as a combinator parser wherein parser combinators (a.k.a. operators in some contexts) are used to define basic parsers, which in turn are utilized to build more complex parsers that can be utilized to build parsers that are even more complex. In other words, parses can be built up piecewise from primitive or less complex parsers. For example, consider the following sample parser combinators:
Atom :: a→Parser a
Empty :: Parser 1
Sequence :: Parser a
   Parser b→Parser a and b
Choice :: Parser b
   Parser c→Parser b or c
Star :: Parser b→Parser b*
Try :: Parser b→Parser b
   Here, the primitives are “Atom” and “Empty.” “Atom” indicates that given a value “a” a parser for that value can be returned, and “Empty” denotes that a parser that returns “1” can be returned if there is no input. “Sequence” takes a parser for “a” and a parser for “b” and returns a parser for “a” and “b.” “Choice” takes a parser for “b” and a parser for “c” and returns a parser for “b” or “c.” “Star” takes a parser for “b” and returns a parser for another “b” denoted “b*,” which addresses recursion. Finally, “Try” takes a parser for “b” and returns another parser for “b” to enable continual search for “b.” Similar combinators can be employed with respect to a regular expression implementation.

Furthermore, with respect to regular expression pattern matching a deterministic finite state machine can be generated that transitions between states depending on the next incoming item. However, in general, it is desirable to recognize the same pattern repeatedly. To do this efficiently, a variant of the Boyer-Moore string matching algorithm can be employed by starting a new recognizing finite state machine (or pre-computing a parallel composition of a finite state machine) when the next incoming value can start a pattern. However, this can assume a finite alphabet by creating a transition “R→x→S” for each proper prefix “R” or a pattern “P” and each character “x ∈ Σ” where “S” is the longest prefix of the pattern “P” that is also a suffix of “Rx.”

Two consequences of working with observable collections are that arbitrary backtracking and look ahead cannot be employed as is conventionally done with strings, files or the like. More specifically, since items of data are being emitted at arbitrary times, one cannot look ahead to items that have not yet been provided. As well, the amount of backtracking can be unbounded and thus it is not desirable to buffer items in the conventional manner to allow for backtracking.

Nevertheless, in accordance with an aspect of the subject disclosure, limited look ahead and backtracking can be utilized if necessary. As per look ahead, this can be accomplished by time shifting a collection of items such that the current item being evaluated is not the most recent item. With respect to backtracking, left factoring can be employed. Here, if a parser, for example, fails without consuming any input (as opposed to succeeding with a value) another parser can “go back” or look at the unconsumed input. In other words, state information can be maintained regarding the failure without consumption of input.

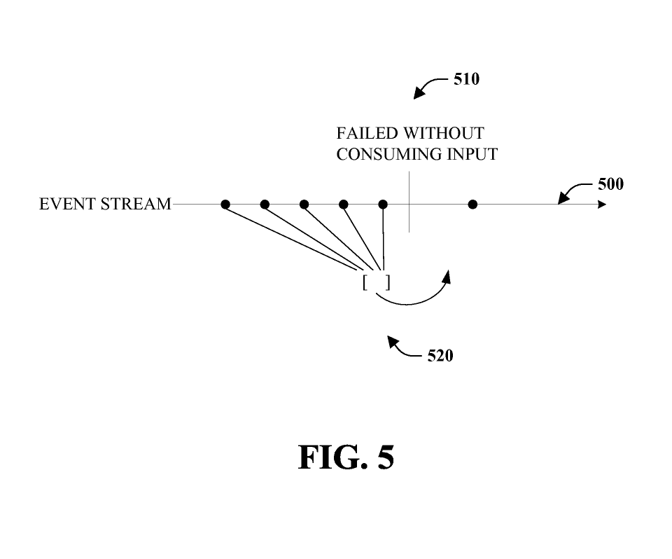

Referring briefly to FIG. 5, an event stream 500 is shown with a plurality of events. Upon failure without consuming input at 510, the unconsumed events 520 can be prepended to events occurring after the failure at 510 such that those events can be analyzed and consumed at some point. Such a representation of failure aids piecewise construction of combinator parsers while also allowing identification of multiple results, for example in the case of ambiguity. Overall, rather than allowing conventional unbounded or unrestricted backtracking, recording or buffering of items such as event can be manipulated more precisely as to when to start and stop buffering of unconsumed items.

Furthermore, it should be appreciated that the parser component 410 can be a monad, or more specifically a monadic combinator parser, for observable collections, wherein a monad is a type of abstract data type constructor that represents computations rather than data. As a practical side effect, other monads can be mapped to a monadic combinator parser such as monad comprehensions or query comprehensions that specify monadic primitives for filtering, transforming, joining, grouping, and aggregating over arbitrary collections of data. Consequently, various query operators (e.g., Where, Select, Join, Take, Skip . . . ) or query expressions employing the query operators can be utilized to express parsers in a more easily comprehensible and familiar form than would otherwise be required. In one particular implementation, a parser can be specified with a language integrated query (LINQ), wherein query operators can be utilized to specify query expressions within a primary programming language (e.g., C#®, Visual Basic® . . . ).

More specifically, the recognizer component 140 can implement LINQ sequence operators so that the recognizer component 140 can be defined with a LINQ query. For parsers, a significant operator can be “choice:”
IParser<T> Choice<T>(this IParser<T> left, IParser<T> right)
   The “choice” operator evaluates its second alternative (right), if the first (left) has not consumed any input. The sequential composition for parsers “p.SelectMany(p)” can track whether “p” has consumed input or not.

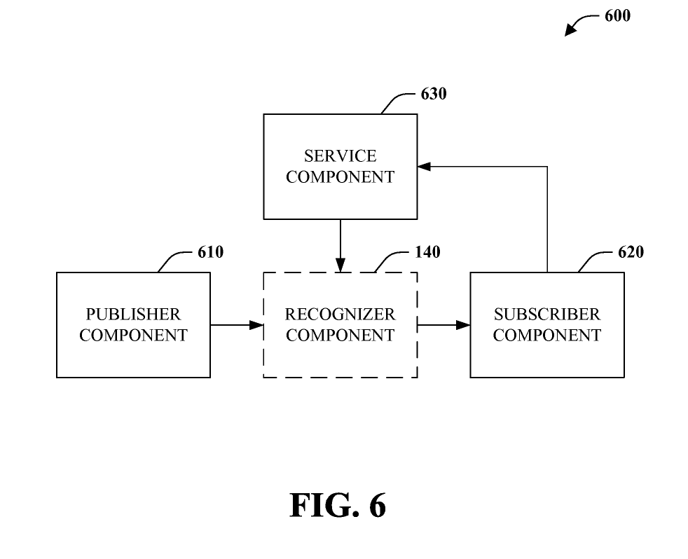

FIG. 6 illustrates a system of data processing 600. Included are a publisher component 610 and a subscriber component 620. In accordance with a publisher/subscriber model, the publisher component 610 publishes data or events, and the subscriber component 620 subscribes to the publish indicating a desire to receive the data or events from the publisher component 610. Moreover, here, the subscriber component 620 can interact with a service component 630 that provides functionality related to filtering data. For example, the service component 630 can generate a recognizer component 140 such as a parser and/or regular expression that can be utilized to identify one or more patterns with respect to push-based data provided by the publisher component 610. Utilizing the capabilities of parsers and like technology can enable identification of more specific and relevant information than is otherwise conventionally available with respect to publisher/subscriber models. For example, filtering is conventionally very coarse grained, such as by filtering by topic. Parsers, however, can enable much more fined grained filtering or pattern recognition.

In accordance with one implementation, the service component 630 can be network accessible service such as a Web service. Furthermore, the service component 630 can provide varying functionality based on credentials supplied by the subscriber component 620 which may reflect election of different features, for instance as a result of payment or non-payment of fees associated with the service. By way of example, limits can be controlled with respect to the number of events that are to be processed or the number of events that filtered out, among other things. Further, yet the complexity of the recognizer component 140 can be modified and storage associated with limited backtracking can be set and adjusted to levels corresponding to particular credentials. In other words, services can be divided and proportioned at arbitrary or predetermined levels.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems above and methods below can include or consist of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the recognizer component 140 can be implemented with such mechanisms to enable intelligent specification and identifications of patterns over push-based data.

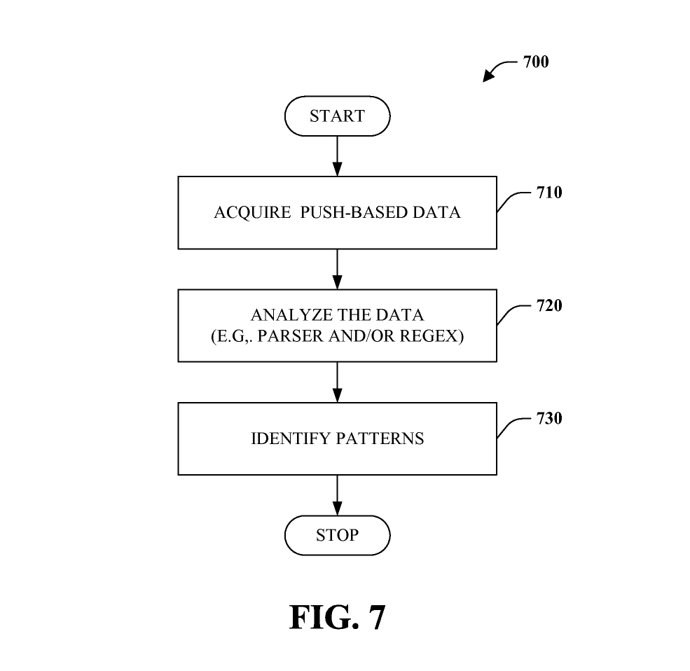

In view of the exemplary systems described supra, methodologies that may be implemented in accordance with the disclosed subject matter will be better appreciated with reference to the flow charts of FIGS. 7-11. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 7, a method of data processing 700 is illustrated. At reference numeral 710, push-based data is acquired, for example, from one or more event streams. At numeral 720, the data can be analyzed utilizing a parser and/or regular expression, for instance. Furthermore, in one implementation, the parser can correspond to a combinator parser that is built up piecewise from primitive or less complex parsers. Still further yet, event analysis at numeral 720 can employ at most limited backtracking and/or look ahead. For instance, left factoring can be employed such that if a parser fails without consuming any input (as opposed to succeeding with a value) another parser can “go back” or view the unconsumed input. At reference numeral 730, any patterns identified as a result of the analysis action can be identified or otherwise output to an interested entity. In accordance with one aspect of the disclosure, discovered patterns of lower abstraction levels can be utilized to create observable collections of a higher abstraction level. For example, “mouseover, mousemove, mouseout” can be replaced by “mousepassed.”

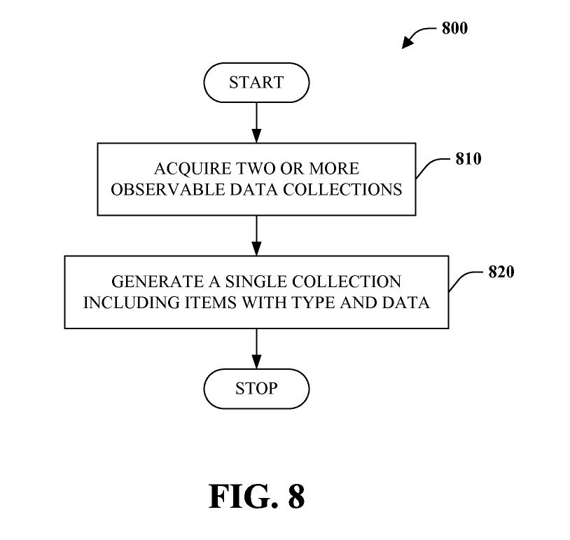

FIG. 8 is a flow chart diagram of a method of collection combination 800. At reference numeral 810, two or more observable data collections can be acquired. At numeral 820, a single collection can be generated from the two or more collections that include items with type and data. In other words, information concerning the type or kind of item can be added to an item (including item data) to enable items from the two or more collections to be distinguished from one another in a single observable collection. In this manner, the problem of analyzing items from across a plurality of collections can be reduced to analyzing items in a single observable collection. In other words, multiple collections or streams become irrelevant to analyzing items.

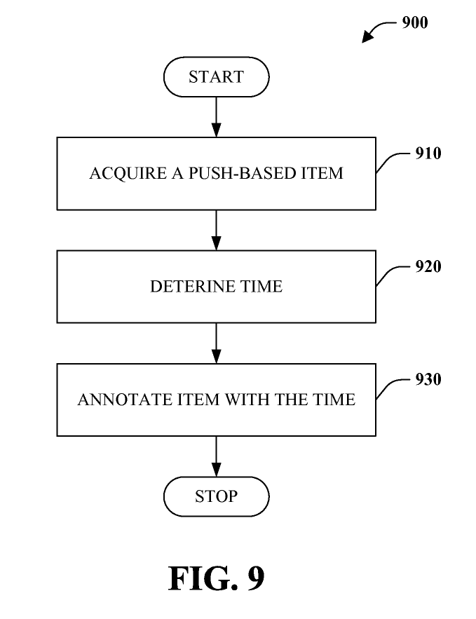

FIG. 9 depicts a method 900 of capturing item time. At reference numeral 910, a push-based item can be acquired, for example from a push-based data source. At 920, the time an item was received is determined At reference numeral 930, the acquired item can be annotated or otherwise labeled with the determined time. Stated differently, the method 900 can time stamp items. In this manner, the duration becomes irrelevant since it can be easily computed as the difference between timestamps.

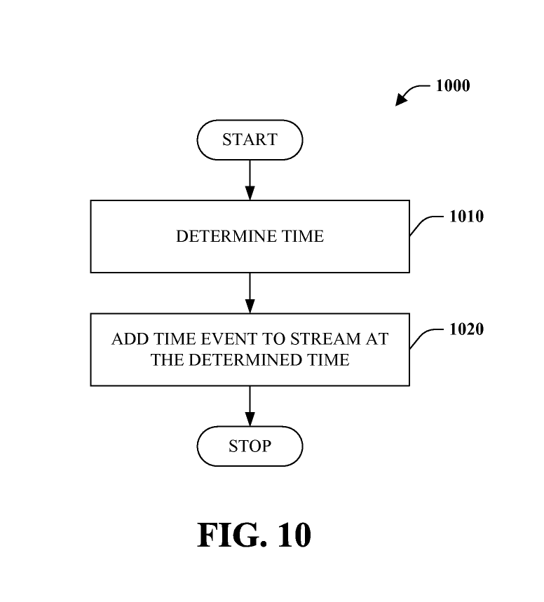

FIG. 10 illustrates a method of capturing item time 1000. At reference numeral 1010, time can be determined In this instance, time can be determined at one or more predetermined intervals that may be relevant to one or more push-based items. At numeral 1020, a time item can be added to an observable collection at the determined time. Stated differently, a time item is added to an observable collection to reflect the passing of a duration of time (e.g., five minutes).

By way of example and not limitation, in the context of events, if a pattern specifies that a first event occur within five minutes of second event, a time event can be inserted into a stream every five minutes. To determine if there is a matching pattern, the analysis can determine whether a time event occurred between the first and second events. If there is a time event between two events then there is no match, as more than five minutes has passed. However, if a time event does not exist then there is a match, since five or less minutes have passed between the occurrences of the first and second events.

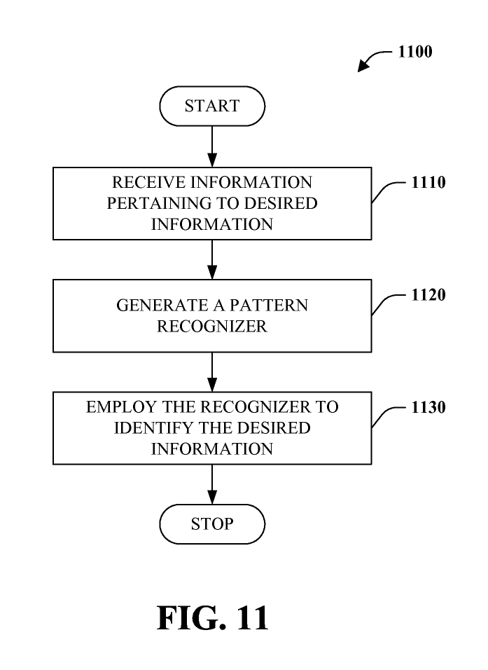

FIG. 11 is a flow chart diagram of a method of data processing 1100. At reference numeral 1110, information is received, retrieved, or otherwise obtained or acquired pertaining to desired information. For example, a query can be received that declaratively specifies information or interest. A pattern recognizer can be generated, at reference numeral 1120, from the information received at 1110. In one embodiment, the pattern recognizer can correspond to a combinator parser, additionally, or alternatively, a regular expression can specify a pattern to match. At reference numeral 1130, the pattern recognizer generated at 1120 can be employed to recognize desired information with respect to observable collections such as event streams. Furthermore, it should be appreciated that the complexity of the generated recognizer and the manner of employment (e.g., events processed, filtered events, storage utilized . . . ) can be adjusted to enable functionality to be controlled and potentially monetized (e.g., purchase rights to some or all functionality).

Aspects of the disclosed subject matter are distinct from a few conventional technology that may appear at least on their face to be similar, namely push and pull-based parsing of XML (eXtensible Markup Language), and complex event processing, streaming, and continuous queries in a database context.

Push- and pull-based parsing of XML refers to the way a parser communicates with its consumers. More particularly, streaming pull parsing refers to a programming model in which a client application calls methods on an XML parsing library when it needs to interact with an XML information set (an abstract data model that represents an XML document as a set of information items). That is, the client only gets (pulls) XML data when it explicitly asks for it. Streaming push parsing, on the other hand, refers to a programming model in which an XML parser sends (pushes) XML data to the client as the parser encounters elements in an XML information set. That is, the parser sends data whether or not the client is ready to use the data at that time. This disclosure pertains to a mechanism for recognizing patterns in observable collections as opposed to the traditional parsing and recognition of patterns that pertain to enumerable collections (e.g., in-memory collections).

Complex event processing (CEP), streaming, and continuous queries are popular in the database community. The model there is that of querying tables to which new rows are added and removed continuously. However, queries are typically done over the tables not over event streams directly.

A problem observable collections face compared to traditional parsing and regular expression matching is that the asynchronous nature makes backtracking or buffering the input difficult or impossible. Moreover, since observable collections are push-based, it is not practical to look ahead at input, which is common with respect to conventional recognizers. Accordingly, patterns need to be recognized with limited or no backtracking or look ahead.

As used herein, the terms “component” and “system,” as well as forms thereof are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner It is to be appreciated a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

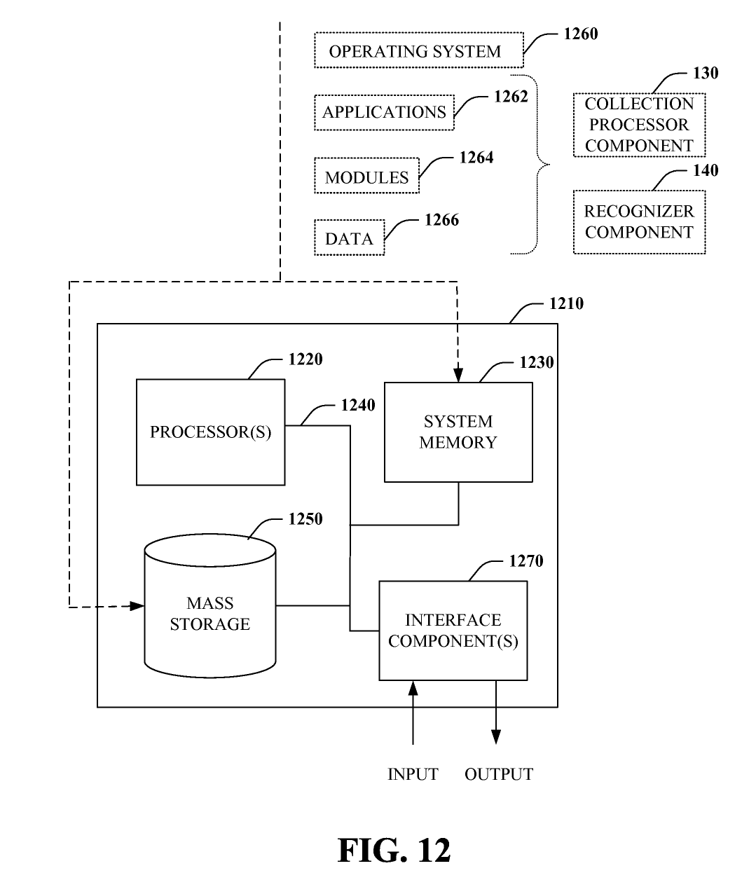

In order to provide a context for the claimed subject matter, FIG. 12 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 12, illustrated is an example general-purpose computer 1210 or computing device (e.g., desktop, laptop, server, hand-held, programmable consumer or industrial electronics, set-top box, game system . . . ). The computer 1210 includes one or more processor(s) 1220, system memory 1230, system bus 1240, mass storage 1250, and one or more interface components 1270. The system bus 1240 communicatively couples at least the above system components. However, it is to be appreciated that in its simplest form the computer 1210 can include one or more processors 1220 coupled to system memory 1230 that execute various computer executable actions, instructions, and or components.

The processor(s) 1220 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 1220 may also be implemented as a combination of computing devices, for example a combination of a DSP and a microprocessor, a plurality of microprocessors, multi-core processors, one or more microprocessors in conjunction with a DSP core, or any other such configuration.

The computer 1210 can include or otherwise interact with a variety of computer-readable media to facilitate control of the computer 1210 to implement one or more aspects of the claimed subject matter. The computer-readable media can be any available media that can be accessed by the computer 1210 and includes volatile and nonvolatile media and removable and non-removable media. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other medium which can be used to store the desired information and which can be accessed by the computer 1210.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

System memory 1230 and mass storage 1250 are examples of computer-readable storage media. Depending on the exact configuration and type of computing device, system memory 1230 may be volatile (e.g., RAM), non-volatile (e.g., ROM, flash memory . . . ) or some combination of the two. By way of example, the basic input/output system (BIOS), including basic routines to transfer information between elements within the computer 1210, such as during start-up, can be stored in nonvolatile memory, while volatile memory can act as external cache memory to facilitate processing by the processor(s) 1220, among other things.

Mass storage 1250 includes removable/non-removable, volatile/non-volatile computer storage media for storage of large amounts of data relative to the system memory 1230. For example, mass storage 1250 includes, but is not limited to, one or more devices such as a magnetic or optical disk drive, floppy disk drive, flash memory, solid-state drive, or memory stick.

System memory 1230 and mass storage 1250 can include, or have stored therein, operating system 1260, one or more applications 1262, one or more program modules 1264, and data 1266. The operating system 1260 acts to control and allocate resources of the computer 1210. Applications 1262 include one or both of system and application software and can exploit management of resources by the operating system 1260 through program modules 1264 and data 1266 stored in system memory 1230 and/or mass storage 1250 to perform one or more actions. Accordingly, applications 1262 can turn a general-purpose computer 1210 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, collection-processor component 130 and recognizer component 140 can be, or form part, of an application 1262, and include one or more modules 1264 and data 1266 stored in memory and/or mass storage 1250 whose functionality can be realized when executed by one or more processor(s) 1220, as shown.

The computer 1210 also includes one or more interface components 1270 that are communicatively coupled to the system bus 1240 and facilitate interaction with the computer 1210. By way of example, the interface component 1270 can be a port (e.g., serial, parallel, PCMCIA, USB, FireWire . . . ) or an interface card (e.g., sound, video . . . ) or the like. In one example implementation, the interface component 1270 can be embodied as a user input/output interface to enable a user to enter commands and information into the computer 1210 through one or more input devices (e.g., pointing device such as a mouse, trackball, stylus, touch pad, keyboard, microphone, joystick, game pad, satellite dish, scanner, camera, other computer . . . ). In another example implementation, the interface component 1270 can be embodied as an output peripheral interface to supply output to displays (e.g., CRT, LCD, plasma . . . ), speakers, printers, and/or other computers, among other things. Still further yet, the interface component 1270 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A method of processing observable collections, comprising:
employing at least one processor configured to execute computer-executable instructions stored in memory to perform the following acts:
performing syntactic analysis with a combinator parser over one or more observable collections.

2. The method of claim 1, further comprises combining multiple observable collections into a single observable collection wherein items of the single observable collection include item type and data.

3. The method of claim 1, further comprises annotating items of the one or more observable collections with time.

4. The method of claim 1, further comprises capturing time as an item in one of the one or more observable collections.

5. The method of claim 4, further comprises capturing time relevant to one or more items as an item in one of the one or more observable collections.

6. The method of claim 1, further comprises generating the combinator parser as a function of a query expression.

7. The method of claim 1, performing syntactic analysis without backtracking.

8. The method of claim 1, maintaining state information corresponding to parser failure without consuming items of the one or more observable collections.

9. A data processing system, comprising:
a processor coupled to a memory, the processor configured to execute the following computer-executable components stored in the memory:
a combinator parser component configured to discover patterns with respect to one or more observable collections.

10. The system of claim 9, further comprises a second component configured to combine items from two or more of the one or more observable collections into a single observable collection.

11. The system of claim 9, further comprises a second component configured to annotate an item of one the one or more observable collections with time.

12. The system of claim 9, further comprises a second component configured to add time items to one of the one or more observable collections.

13. The system of claim 9, the combinator parser is generated based at least in part from a query expression.

14. The system of claim 9, the combinator parser is configured to identify patterns without backtracking.

15. The system of claim 9, the combinator parser is configured to maintain state corresponding to failure of a parser combinator without consumption of input.

16. The system of claim 9, the one or more observable collections are one or more event streams.

17. A method of processing observable data, comprising:
employing at least one processor configured to execute computer-executable instructions stored in memory to perform the following acts:
generating a combinator parser; and
recognizing one or more patterns in a collection of observable data with the parser.

18. The method of claim 17, generating a parser of a predetermined complexity.

19. The method of claim 17, generating a parser with a predetermined amount of storage for maintaining state.

20. The method of claim 17, generating a parser that operates over a predetermined number of collections of observable data.
